(19) United States
(12) Patent Application Publication
(10) Pub. No.: US 2017/0161831 A1
(43) Pub. Date: Jun. 8, 2017

(54) PRODUCT PARAMETERS DEFINED WITH RESPECT TO ANOTHER PRODUCT

(71) Applicant: BGC PARTNERS, INC., New York, NY (US)

(72) Inventor: Michael Schmanske, New York, NY (US)

(21) Appl. No.: 15/369,315

(22) Filed: Dec. 5, 2016

Related U.S. Application Data
(60) Provisional application No. 62/263,201, filed on Dec. 4, 2015.
(60) Provisional application No. 62/264,569, filed on Dec. 8, 2015.

(51) Int. Cl. G06Q 40/04; G06Q 30/02

(52) U.S. Cl. CPC G06Q 40/04; G06Q 30/0283

(57) ABSTRACT

Various embodiments are directed to a system and method for specifying a transaction for a product having a parameter such as price (e.g., strike price) defined with reference to a parameter (such as price) of another asset. In some embodiments, at least one processor may receive indicia indicating a trading product having a price defined as a differential to a reference product. At least one processor may determine a price of the reference product. At least one processor may calculate a price of the trading product by adding the differential to or subtracting the differential from the price of the reference product. The calculated price may be transmitted via a network to an output device.

### RELATED APPLICATIONS

The present application claims the benefit of U.S. Ser. No. 62/263,201 filed Dec. 4, 2015 and U.S. Ser. No. 62/264,569 filed Dec. 8, 2015, the disclosures of which are incorporated by reference herein in their entireties.

### BACKGROUND

In traditional trading systems, trading products such as VIX are settled to themselves. (VIX is a trademarked ticker symbol for the CBOE Volatility Index, a popular measure of the implied volatility of S&P 500 index options. The S&P 500 is the Standard and Poor's 500 stock index, and is also called “SPX.”) In other words, a trading product such as the VIX will be settled at the price of VIX.

One example of a trading product is a variance swap, which offers straightforward and direct exposure to the volatility of an underlying (e.g., an underlying index, stock, financial instrument, etc.). In a variance swap transaction, a buyer may pay a variance swap strike price, and a seller may pay the realized variance at expiry. As noted in an article by the European Equity Derivatives Research of J.P. Morgan Securities Ltd. entitled “Variance Swaps” (available at: http://quantlabs.net/academy/download/free_quant_institutitional_books_/%5BJP%20Morgan%5D%20Variance%20Swaps.pdf), variance swaps can be replicated by a delta-hedged portfolio of vanilla options, so that pricing reflects volatilities across the entire skew surface.

The CBOE Volatility Index (“VIX”) is quoted in percentage points and translates, roughly, to the expected movement in the S&P 500 index over the upcoming 30-day period, which is then annualized. VIX is a trademarked ticker symbol for the CBOE Volatility Index, a popular measure of the implied volatility of S&P 500 index options. The VIX is calculated by the Chicago Board Options Exchange (CBOE). Often referred to as the fear index or the fear gauge, the VIX represents one measure of the market's expectation of stock market volatility over the next 30-day period.

The VIX may use a total premium calculation that replicates the value of a 30 day variance swap. Once a month, on VIX expiration, this price is equal to the price of a variance swap settling on the next month's SPX expiration. To trade this settlement as a basket of listed options is extremely difficult and expensive. It can also be very expensive in margin terms to carry. To avoid these issues, many traders do not take delivery of VIX but instead divest it before it expires.

### BRIEF SUMMARY

In some embodiments, a product such as a variance swap may have a price or other parameter tied to a parameter of a reference product. For example, a product such as a variance swap may have a price (such as a strike price) that is defined with reference to another trading product such as the VIX. For example, a variance swap may have a strike price determined by a price differential to the VIX.

### BRIEF DESCRIPTION OF THE FIGURES

FIG. 1 depicts a system according to at least one embodiment of the systems disclosed herein.

FIG. 2 depicts a flow chart according to at least one embodiment of the methods disclosed herein.

### DETAILED DESCRIPTION OF EXEMPLARY EMBODIMENTS

Various embodiments are directed to a system and method for specifying a transaction for a product having a parameter such as price (e.g., strike price) defined with reference to a parameter (such as price) of another asset. In some embodiments, at least one processor may receive indicia indicating a trading product having a price defined as a differential to a reference product. At least one processor may determine a price of the reference product. At least one processor may calculate a price of the trading product by adding the differential to or subtracting the differential from the price of the reference product. The calculated price may be transmitted via a network to an output device.

In some embodiments, a product such as a financial instrument may have a parameter such as a price (such as a strike price) be determined based on the price of another asset. For example, one financial instrument may have a price that is a fixed amount above (or below) a particular Treasury note (e.g., a 5-yr note with a defined expiration), index, or other asset.

A contract or other agreement may specify a trade or other transaction for a trading product. The trading product may comprise a variance swap. In some embodiments, the trading product may comprise another realized or floating rate product, e.g., where the strike price is determined by a price differential to another asset. In some embodiments, the trading product may comprise any type of trading product, such as a financial instrument, a currency exchange, currency swaps, a good or service, or other item exchangeable for value.

For example, in one embodiment: the VIX may use a total premium calculation that replicates the value of a 30 day variance swap. Once a month, on VIX expiration, this price is equal to the price of a variance swap settling on the next month's standard SPX expiration (e.g., the morning special Index Opening Settlement on the third Friday of each month). To trade this settlement as a basket of listed options is extremely difficult and expensive. It can also be very expensive in margin terms to carry.

In some embodiments, instead of (or in addition to) trading the VIX, traders could agree days (or weeks) prior to buy (or sell) a variance swap at a number (N) of basis points (“bps”) of volatility above or below the VIX settlement price.

In an exemplary embodiment, a first user may purchase 100,000 Oct variance swap at 12 basis points (“bps”) over VIX settle. Until VIX expiration, the first user has a position in implied volatility with zero mark to market. On VIX expiration (e.g., the morning opening trade 30 days prior to the next standard SPX expiration), settlement is determined to be 16.20. That night, the first user would be long 100,000 vega of variance swap struck at 16.32 (that is, 16.20±0.12). The user may trade all or a portion of the 100,000 Oct variance swap. The 100,000 Oct variance swap settles to the physical variance swap. In other words, the first user may effectively buy or sell a financial product priced at “VIX+12”, wherein the exact price is not known until the VIX settles.

(As explained at www.investopedia.com, vega is the measurement of an option's sensitivity to changes in the volatility of the underlying asset. Vega represents the amount that an option contract's price changes in reaction to a 1% change in the volatility of the underlying asset. Volatility measures the amount and speed at which price moves up and down, and is often based on changes in recent, historical prices in a trading instrument. Vega changes when there are large price movements (increased volatility) in the underlying asset, and falls as the option approaches expiration.)

It should be appreciated that many types of formulas and algorithms could be used to relate the parameter of one financial product to another. For example, a relationship could be linear (e.g., P=P(ref)+N, as described above with respect to a price differential). A relationship could also be a step function (e.g., using ranges), another polynomial function, an exponential function, or any other mathematical relationship.

It should also be appreciated that the parameter of the trading product and the reference product need not be the same type of parameter. For example, an interest rate of a trading product may be defined with reference to a number of points or a price of a reference asset.

In some embodiments, a financial instrument may have an interest rate or other parameter defined with respect to possible ranges of a reference variable such as VIX. For example, if VIX closes above 30, the interest rate may be set to 5%; if VIX closes between 25-30, the interest rate could be set to 4%; if VIX closes between 20-30, then the interest rate could be set to 3%; etc. In some embodiments, smaller ranges could be specified, such as: if VIX closes between 29-30, then 4.75%, if VIX closes at 27-28, then 4.5%; etc.

For some exemplary embodiments involving a variance swap priced according to VIX, differences between some embodiments and a classic variance swap contract may include:

a) Strike price floats and is finally set based on a specified differential, such as a number (“N”) of basis points spread from VIX settlement;

b) First price observation for the realized portion of the variance swap is set via the opening price of the SPX, {SPXSET}. (As explained at www.cmegroup.com, domestic stock index futures traded on CME Group exchanges and on other exchanges are typically settled to a “Special Opening Quotation” (“SOQ”). SOQs are calculated per normal index calculation procedures except that the values for the respective components are taken as the actual opening values for each of the component equities. The SOQ for the S&P 500 may be referenced on Bloomberg systems with the ticker symbol “SPXSET <INDEX>”.); and

c) First return observation is the change from SPXSET and the closing price of the SPX that evening.

Some embodiments may achieve one or more advantages over some conventional systems and methods. For example, instead of divesting VIX before it expires, users could hold onto their existing volatility exposure. Traders holding VIX would better understand their risk before and after VIX expiration. Some embodiments would avoid various margin issues of holding large quantities of listed options. Some investors that do not have access to the VIX expiration process could convert their positions to the equivalent expiration position.

In some embodiments, the trading products may be traded electronically or via voice brokerage.

In some embodiments, various features of the embodiments described herein could be applied to any other financial product(s) that shares a valuation metric, e.g., any financial instrument that swaps forward looking implied to backward looking realized. For example, other embodiments may involve realized rate swap trading vs. the Eurodollar strip.

In another example, one or more financial products may be priced according to a future price of a reference product such as a Treasury note. For example, a Treasury swap may be priced according to “10-yr Treasury Note+25 basis points”. For example, the Treasury swap could have a price that is equal to 25 basis points plus the closing price of a specific 10-yr Treasury Note at a specific time.

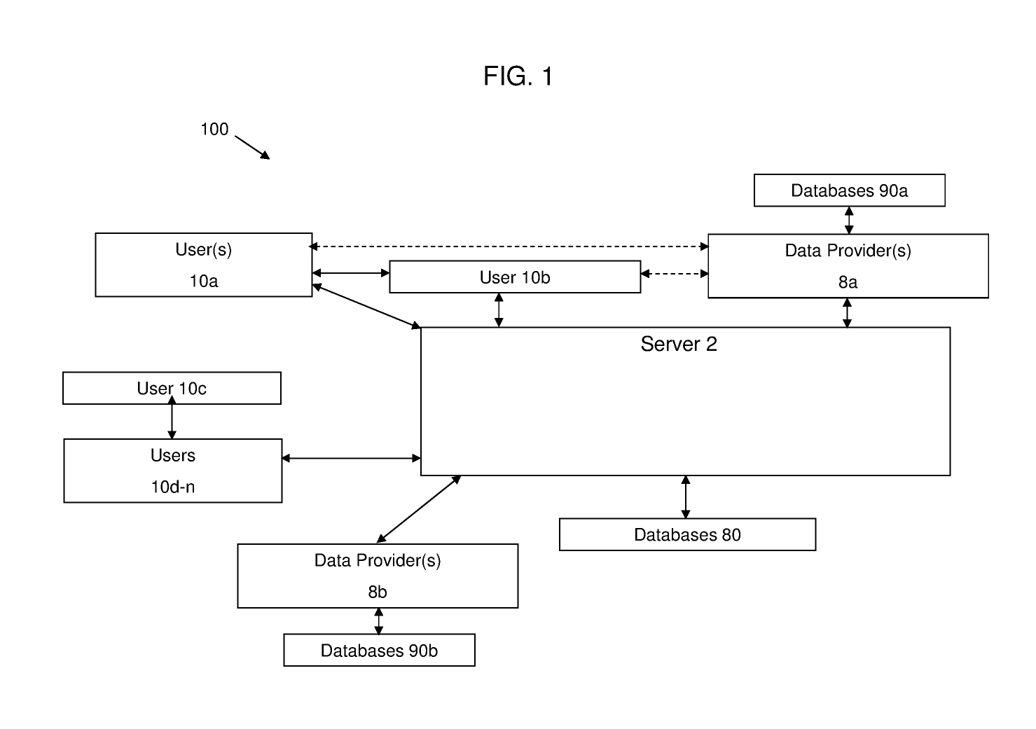

FIG. 1. Exemplary System

Some embodiments of the present invention provide systems and methods for pricing one or more trading products, e.g., with reference to another product or asset. FIG. 1 depicts a system according to at least one embodiment of the systems disclosed herein.

The system 100 may comprise one or more servers 2 coupled to one or more databases 80, one or more data providers 8a-8n, one or more end users 10a-10n, and one or more agents 12. The data providers 8a-8n, users 10, agents 12, and server 2 may each communicate with each other. Users 10 may also communicate with other users 10.

System 100 and server 2 may perform the communication, pricing, and order processing functions described herein.

Server 2 may comprise one or more processors, computers, computer systems, computer networks, and or computer databases. Server 2 may comprise modules. Server 2 may also comprise one or more databases, such as databases 80. Server 2 may communicate with users 10, data providers 8, and agents 12. For instance, server 2 may communicate with a user 10 computer, such as a browser of a user computer, e.g., over the internet.

Databases 80 may comprise one or more processors, computers, computer systems, computer networks, and/or computer databases configured to store information. Each of databases 80 may communicate with server 2, e.g., via one or more modules of server 2. For instance, server 2 and modules may store information in databases 80 and may also use information stored in databases 80.

Users 10a-10n may comprise one or more human persons, computers, terminals, users, traders, trading entities, or other entities. Users 10 may interact with agents 12, server 2, and/or other users 10. As used in this application, users 10a-10n may also refer to a user's interface to other system 100 components (like server 2), such as a user's PDA or computer or a program running on a user's computer such as a computer web browser like Internet Explorer™, which may communicate with data providers 8, agents 12, and/or server 2.

Data provider(s) 8 may comprise any person, processor, information service, or other entity that publishes or otherwise provides information relating to one or more financial instruments, markets, trading platforms, traders, orders, or other financial- or trade-related information. In some embodiments, the data may include information that may be of interest to or used by a user 10 or server 2.

Data provider 8 may provide information in real time, as information is created or as it first becomes available to the general public, or at another time. Data provider 8 may provide such information in any one or more of a variety of forms and means such as video, audio (e.g., radio broadcast), text (e.g., stock ticker-type information), or other data that may convey information. Data may be provided at a variety of different timings. In some embodiments, data may be provided in periodically, continuously, or continually, e.g., via a data feed (e.g., a stream of data that includes real time updates of trading-related information). In some embodiments, data may be provided after an event, e.g., a trade or submission of an order.

In some embodiments, data provider 8 may provide to server 2 (and/or agents 12 and/or users 10) trading-related information.

Intermediaries 12 may comprise one or more trading-related entities such as a broker, fund manager, or other entity that interacts with users, data providers, and server, but is separate from those entities.

The server 2 may comprise a computer, server, hub, central processor, or other entity in a network, or other processor. The server 2 may comprise input and output devices for communicating with other various system 100 elements. In some embodiments, the server 2 may comprise a trading platform, an exchange, a fund or fund management system, an order matching system, or other processing system.

In some embodiments, the server 2 may be comprised in an end user's computer 10, e.g., as a toolbar in a user's web browser or another program running on the user's computer.

As shown in FIG. 1, the server 2 may comprise a plurality of modules. Each module may comprise a processor as well as input and output devices for communicating with other modules, databases, and other system elements.

User interface module 22 may communicate with users.

User interface module 22 may cause information to be output to a user, e.g., at a user output device such as a display device (e.g., a display device at a user terminal), a speaker. The information outputted to a user may be related to a user account, preferences, and other information described herein. User interface module may communicate the information electronically, e.g., via networked communication such as the internet (e.g., in an email or webpage), telecommunication service, etc. In some embodiments, user interface module 22 may comprise input devices for users to communicate trading-related information.

User preferences module 24 may receive, identify, or determine user preferences concerning one or more portfolios. For instance, the module may receive the preferences from a user interacting with a user interface. The module may also receive them from an automated user terminal. The module may also determine them based on a program that automatically determines user preferences concerning one or more portfolios or securities.

Financial information module 26 may determine financial information associated with one or more orders, trades, financial instruments, portfolios, indices, financial metrics, and other financial information.

Search module 28 may search for and/or identify and/or solicit one or more securities, orders, and/or counter-parties, e.g., concerning one or more orders. For instance, search module may search one or more financial databases (e.g., a database that stores orders or counter-party preference information), e.g., via the internet, to determine one or more securities or orders that satisfy one or more parameters, such as parameters based on preferences from a user.

Price module 30 may determine and associate one or more values or prices (or other parameters) with one or more orders, securities, portfolios, or other financial entities, e.g., as described herein. For instance, price module 30 may determine a price, e.g., for an order, or to be paid to or received by a user or server, e.g., for one or more securities. For instance, price module may determine a price or value (such as a net present value) that an entity such as a fund is willing to pay for or sell a particular portfolio (e.g., a quantity of a security offered for purchase or sale, e.g., in a trading order). Prices may include a current price, a historical price (e.g., a price such as a market price at a prior time, such as a week earlier), and an estimated future price (e.g., based on changing price information, such as a recent increase or decrease in a price over a recent period of time).

As shown in FIG. 1, a database 80 may be coupled to the server 2. The database 80 may comprise a plurality of databases as described below. Databases 80 may store information about users, trading products, and other information.

The modules may function separately or in various combinations. While the modules are shown within a single server, the modules may also operate among several servers. The modules may communicate with a plurality of databases, which may also function collectively or separately.

The modules of server 2 may store, access and otherwise interact with various sources of data, including external data, databases and other inputs.

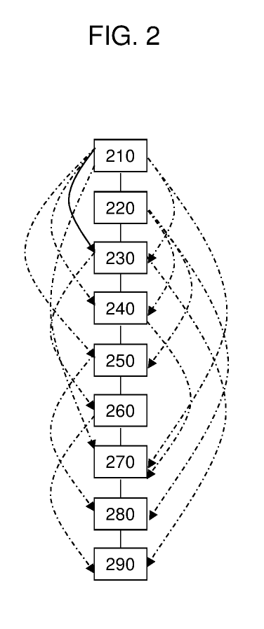

FIG. 2: Exemplary Method

In block 210, a trading product may be created so that it has at least one parameter tied to at least one other reference product. For example, the trading product may be created such that it has a price component defined with respect to a first reference product and an interest rate defined with respect to a second reference product. In some embodiments, the trading product may have multiple parameters defined with respect to a single reference product.

For example, a trading product such as a variance swap may be defined to have a price that is a spread above or below a reference product such as the VIX, e.g., a spread such as 2 basis points above or below VIX.

In block 220, the trading product may be traded, e.g., via an electronic trading system.

In block 230, at least one processor receives indicia indicating a trading product having a parameter such as price defined with reference to at least one other product, e.g., a price defined as a differential to a price of a reference product. For example, the processor may receive from a computer component (e.g., a user terminal), an user input device, or other component indicia indicating a financial instrument such as a variance swap.

In block 240, an event may occur that causes at least one reference product's parameter to be realized. For example, if the reference product is the VIX, the VIX may settle at a defined price, e.g., on a particular Wednesday of a given month.

In block 250, the at least one processor may determine the realized parameter (such as price) of the reference product. For example, information about the VIX settlement price may be transmitted to the at least one processor.

In block 260, the at least one processor may determine a parameter of the trading product based on the realized parameter of the reference product(s). For example, the at least one processor may calculate a price of the trading product according to a predefined formula or other algorithm, e.g., based on a realized parameter of the reference product. For example, the at least one processor may add or subtract a defined differential to or from the determined price of the reference product. For example, the variance swap may be determined to have a price equal to the VIX price adjusted by the differential.

In block 270, the at least one processor may output the determined parameter (such as price) of the trading product, e.g., at a user display device.

In block 280, the trading product may be traded one or more times, e.g., between two or more users of a trading system.

In block 290, one or more additional parameters of one or more other reference products may be realized, and corresponding parameter(s) of the trading product may be defined. The trading product may be traded one or more additional times.

In some embodiments, the trading product may be settled, traded, or otherwise used by one or more users. In some embodiments, once the parameter is defined, the product may continue as it did previously (except that now the parameter is fully defined).

It should be appreciated that the actions described in the blocks for the methods described herein are exemplary only, and need not be performed in the order presented here. Further, it is not necessary to accomplish all of the actions described in the blocks. Rather, any number of the blocks (e.g., four of the blocks or six of the blocks) may be accomplished, and in any order. Further, the actions described herein may be combined with any other actions described herein, in any order.

### EXAMPLE 1

Variable return swaps striking to a related forward looking contract.

An exemplary non-limiting embodiment is described here in Example 1, which relates to an exemplary Variance to VIX contract.

Proposal: To create a mechanism by which a variable returns based swap can be struck at a price based on a different but related forward looking product so parties can better manage risk exposures across expiration cycles. Products this business process would apply to include Rate swaps striking off of Libor based forward contract (e.g. Eurodollar futures), Long dated rate swaps striking off of Treasury futures, Realized Credit swaps striking off of credit index futures and more. For the purposes of this description we will be using Variance swaps that strike off of the VIX futures settlement price.

Description of the VIX: The VIX also known as the “fear index” is a product owned by the Chicago Board Options Exchange (CBOE). Futures on this index trade on the CBOE Futures Exchange (CFE). A detailed description of the calculation methodology can be found here: http://www.cboe.com/micro/vix/vixwhite.pdf.

Briefly, the VIX index calculation is based on the implied volatility of the options on the S&P 500 index 30 days from the VIX expiration date. The weights of the options used in the calculation mimic the calculation of the fair value of a 30 day variance swap. The VIX is a forward-looking instrument that settles to an implied price level.

Description of Variance: Variance swaps can be described as realized volatility instruments that settle to the backward looking realized variance over the life of the contract. In some embodiments, a buyer pays a fixed implied volatility and receives realized returns for the term specified. Since the calculation of the VIX settlement closely tracks the fair value of a variance contract, there may be a natural transition between the two on VIX expiration. (In some embodiments, this may not be necessary for the business process to be useful.) Variance is a backward-looking realized instrument that settles to actual realized returns.

VIX Expiration: VIX futures expire to a cash value based on the opening print in the basket of options on the SPX index 30 days from VIX settlement date. To properly manage an expiring VIX position a party must buy (or sell) the entire strip of options, thus guaranteeing a continuation of their market exposure. This is difficult and can be very expensive. It also leaves the investor with a large and unwieldy position of listed options contracts. Banks and large market making firms have the capacity to transact in this market but many market participants find this difficult. On expiration a long position in VIX futures either “goes away” or converts to a large basket of difficult-to-manage listed options via an expensive basket execution process.

Conversion: In an exemplary embodiment, the expiring VIX futures contract can convert directly into a variance swap, greatly simplifying the expiration and risk management process for investors. Before expiration a holder of a long (or short) futures position could buy (or sell) a variance swap striking at X basis points above or below the VIX expiration price.

Example: Investor A has 500 long VIX futures expiring on the October VIX Expiration (e.g., Wednesday, Oct. 21, 2015). Two days later (e.g., on Friday, Oct. 16, 2015) they agree to buy 500,000 vega of November variance from Market Maker B paying VIX settlement less 20 bps. On VIX expiration the VIX basket of November SPX options settles to a price of 19.34. After expiration investor A is now long 500,000 vega of November Variance struck at 19.14 (that is, 19.34 minus 20 bps).

The first price observation of the variance swap is the opening print of the SPX index that day. [SPXSET {Index} ticker on Bloomberg]. The first return observation is the closing price of the SPX index that evening. Afterwards the Variance swap may calculate normally.

Every expiration cycle the Variance to VIX contract may trade at different premiums based on inventories, demand, business day calculations, convexity values and a number of other adjustments. In some embodiments, this may not be a case of a clear cut translation between one product and price to another, but rather a liquid and dynamic market.

It should be appreciated that many variations of this Example 1 are also contemplated.

### EXAMPLE 2

### Exemplary Term Sheet

The following is an exemplary Term Sheet that illustrates various features of products described herein. For example, this Term Sheet may be used for trading products similar or identical to the one described in Example 1.
Trader: John Doe
Trade Date: Dec. 7, 2015
Buyer of Variance: ABC Bank.
Seller of Variance: 123 Bank
Final Valuation Date: Oct. 16, 2015
Underlying Equity: Closing Price of the SPX Index
Frequency of Observation: Daily
Currency: USD
Vega Notional: 50,000
Variance Units: TBD Vega Notional/(2 X Volatility Strike)
Volatility Strike: VIX Settlement—0.20 [Volatility Strike is only for indicative purposes.
Payoff is linked to Variance, not Volatility]
Variance Strike: TBD (Volatility)̂2
n=18
Initial Underlying Level (P1): Cash opening price on VIX expiration date
Second Underlying Level (P2): Cash close price on VIX Expiration date
Var Buyer Final Payment: Variance Units*Max [0, Variance Strike−Volatilitŷ2]
Var Seller Final Payment: Variance Units*Max [0, Volatilitŷ2−Variance Strike]
Payment Date: T+2 (adjustments according to Following Business Day Conventions)
Realized Volatility: Actually realized Daily Volatility is defined according to the following formula:

$$\sqrt{252} * \sqrt{\frac{{\sum }_{i = 1}^{m} {[ ln ( \frac{{C}_{i + 1}}{{C}_{i}} ) ]}^{2} * 10 , 000}{n}}$$

where:

n=, meaning the number of days that, as of the trade date, are expected to be scheduled trading days for the period from and including the Trade Date to, and including, the scheduled valuation date

m=n, unless there is a market disruption event

Ci=the daily closing price of the underlying on the ith business day starting on the day following Trade Date

(i=2), and Cm shall be equal to the EDSP expiration of the underlying on the Final Valuation Date.
Business Days Per Year=252
Market Disruption: Refer to ISDA
Swapswire ID: 53390789
USI Prefix: 1010000283 M138X20150922XEQ003031994423XXXX
Brokerage: S0.

Exemplary inputs may comprise one or more (or all) of the following:
Trader John Smith
Buyer ABC Bank
Seller 123 Bank
Maturity Date Oct. 16, 2015
Underlying SPX Index
Vega 50,000
Vol Strike 22.050
N=18
Brokerage S0
SW ID: 53390789
USI: 1010000283 M138X20150922XEQ003031994423XXXX

It should be appreciated that many variations of this Example 2 are also contemplated.

### EXAMPLE 3

### A Second Exemplary Term Sheet

The following describes exemplary terms for an end of day combo, e.g., an end of day combo (custom).
End of Day Combo Terms.
Trade Date: Dec. 7, 2015.
Product: SPX
Structure: OTC Options, Combo
Buyer: Morgan Stanley & Co. International PLC
Seller: JPMorgan Chase Bank N.A London
Currency: USD
Option Type: European Put
Maturity Date: Sep. 19, 2016 (or another date like Sep. 19, 2014 or 2019)
Basis: −5.550
Strike: 1,964.5200
Number of Units: 20,300
Notional Amount: $39,879,756.00
Put Premium: $1.00
Total Premium: $20,300.00
Payment Date of Premium: 2 business days.
Other Terms: Options expire vs EDSP.

Exemplary data and/or inputs may include the following:
Buyer: JPMorgan Chase Bank N.A London
Seller: Morgan Stanley & Co. International PLC
Maturity Date: 19 Sep. 2014
Notional: $40,000,000.00
UNITS 20,300
Cash Close: 1970.07
Basis (Trade Level) −5.55
C/P Premium 1
Strike 1,964.5200
Brokerage: 812
920

Exemplary terms for another exemplary end of day combo (e.g., custom) comprise the following:
Trade Date: Dec. 7, 2015.
Product: SPX
Structure: OTC Options, Combo
Buyer: JPMorgan Chase Bank N.A London
Seller: Morgan Stanley & Co. International PLC
Currency: USD
Option Type: European Call
Maturity Date: Sep. 19, 2016 (or another date like Sep. 19, 2014 or 2019)
Basis: −5.550
Strike: 1,964.5200
Number of Units: 20,300
Notional Amount: $39,879,756.00
Put Premium: $1.00
Total Premium: $20,300.00
Payment Date of Premium: 2 business days.
Other Terms: Options expire vs EDSP.
Brokerage: $812.

It should be appreciated that many variations of this Example 3 are also contemplated.

### EXAMPLE 4

### A Third Exemplary Term Sheet

The following describes exemplary terms for an end of day combo.
Trade date: Dec. 7, 2015.

Product: SPX.
Structure: OTC Options, Combo.
Buyer: 0. Seller: 0.
Currency: USD.
Option Type: European Put.
Maturity Date: Sep. 19, 2017 (or another date like Sep. 19, 2014 or 2019).
Basis: 0.800
Strike: 4,312.3740
Number of Units: 8,118
Notional Amount: $35,006,494.15
Put Premium: $1.00
Total Premium: $8,117.69
Payment Date of Premium: 2 Business Days.
Other Terms: Options expire vs. EDSP.

Exemplary inputs may comprise one or more (or all) of the following:
Maturity Date: 19 Sep. 2014
Notional: $35,000,000.00
UNITS: 8,118
Cash Close: 4311.574 (e.g., enter in red)
Basis (Trade Level) 0.8 (e.g., change)
C/P Premium 1
Strike 4,312.3740 (e.g., leave)
Brokerage:324.7074038

(−7.1)

(4304.474)

33593000

920

Exemplary terms for another exemplary end of day combo (e.g., NDXX) comprise the following:
Trade date: Dec. 7, 2015.
Product: SPX.
Structure: OTC Options, Combo.
Buyer: 0. Seller: 0.
Currency: USD.
Option Type: European Put.
Maturity Date: Sep. 19, 2016 (or another date like Sep. 19, 2014 or 2019).
Basis: 0.800
Strike: 4,312.3740
Number of Units: 8,118
Notional Amount: $35,006,494.15
Put Premium: $1.00
Total Premium: $8,117.69
Payment Date of Premium: 2 Business Days.
Other Terms: Options expire vs. EDSP.
Brokerage: $324.71.

It should be appreciated that many variations of this Example 4 are also contemplated.

### EXAMPLE 5

### A Fourth Exemplary Term Sheet

The following describes exemplary terms for an end of day combo. In some embodiments, this may relate to a 5y 100.115 cs DP.
End of Day Combo Terms.
Attention: HSBC Bank PLC
Trader: Jane Doe
Trade Date: Dec. 7, 2015 (or another date)
Product: SPX
Structure: OTC Options, Put
Buyer: HSBC Bank Plc
Seller: Toronto Dominion Bank Toronto
Currency: USD
Option Type: European Put
Maturity Date: Nov. 27, 2020 (or another date like Nov. 27, 2018 or 2019).
Basis: −1.250
Implied Cash: 2069.250
Strike: 1,241.550 60% of Spot
Number of Units: 4,833
Notional Amount: $10,000,685.25
Delta: 13.00% To the 60% Put
Put Premium: 6.100% =$126.2243
Total Premium: $610,042.04
Payment Date of Premium: Premium paid at Maturity+2 Business Days.
Delta Hedge: Synthetic Forward Combo.
Hedge Cross Level: 2068
Implied Cash Level: 2069.25
Options Crossed On: OTC
Other Terms: Options Expire vs cash close. Delta Hedge expires vs. EDSP.
Delta Hedge:
HSBC Bank Plc
Buys 628 Dec. 19, 2016 2068 Strike EDSP Calls from Toronto Dominion Bank Toronto.
Sells 628 Dec, 19, 2016 2068 Strike EDSP Puts from Toronto Dominion Bank Toronto.
Both for $1.00.
Please remit payment in the amount of X dollars, e.g., $1000 dollars.

Exemplary inputs may comprise one or more (or all) of the following:
Buyer: HSBC Bank Plc
Trader: Johnny Doo
Seller: Toronto Dominion Bank Toronoto
Trader: Allen Yoo
Underlying: SPX
Structure: Put Ratio
Put Strike: 60.00%
Futures Level: 2068
Basis: −1.250
Put Premium %: 6.100% Buy
Trade Level: 6.100% Delta Direction to the 60% Put
Delta %: 13.00%
Notional: $10,000,000
Currency: USD
Payment Type: DP
Maturity Type Put: USRegular
Maturity Date Put: Nov. 27, 2020 (In some embodiments, expire vs EDSP)
Strategy Spread
Front Month Futures: Dec. 19, 2014 (or 2016)
Buyer Combo (Calls): HSBC Bank Plc
Brokerage Rate: $0.000100
Bill # of Legs: 1 Leg; $1,000

In some embodiments, an interface may confirm (or not confirm) that a trade described or mentioned herein has been confirmed, e.g., on Swapswire.

### Swap:

Fixing Date: Dec. 7, 2015
Starting Date: Dec. 9, 2015
Last Payment Date: Dec. 9, 2020
Rate: 0.880%

It should be appreciated that many variations of this Example 5 are also contemplated.

Additional non-limiting examples are described in the Appendix attached hereto, such as additional exemplary term sheets and inputs corresponding to various exemplary embodiments. It should be appreciated that slight variations and large variations of these examples are also contemplated.

In some embodiments, parameters and terms such as prices, interest rates, volumes, dates, notional amounts, delta hedge information, implied cash, strike, put premiums, payment dates, and other parameters (e.g., of a financial instrument) may be configured and adjusted by one or more parties, e.g., via a user interface. For example, a user may input a at a user interface a plurality of parameters that specify a specific financial instrument.

In some embodiments, a user may search for one or more trading products that satisfy one or more criteria. For example, a user may specify search terms and/or one or more parameters (or ranges of parameters, such as an interest rate between 3% and 4%, or a price between $1000 and $10001). In response to the search query, a processor may search a database storing information about a plurality of trading products and return one or more search results that satisfy the query.

In some embodiments, users may trade trading products, e.g., via trading systems and via interfaces described or incorporated herein.

In some embodiments, the term sheets in the examples above may describe a transactional billing statement. In some embodiments, each term sheet may not be a confirmation of a trade. Rather, the trade described in the term sheet may be subject to direct confirmation between the buyer and seller.

In some embodiments, the information described in one or more of the examples may be displayed, e.g., to a trader, on a graphical user interface. The interface may display selectable indicia for buying and selling trading products described, linked, mentioned, or otherwise associated with the information presented above, and may display indicia selectable for resetting the data.

Although many embodiments are described with reference to variance swaps and VIX, it should be appreciated that the features described herein may be applied to other trading products such as other products, services, and financial instruments such as stocks, bonds, swaps, options, and other derivatives.

In various additional embodiments, each of the features described herein may also be configured to operate within the trading systems described in U.S. Patent Publication No. 2014/0229353 to Lutnick et al., entitled “SYSTEMS AND METHODS FOR DETECTING INTEREST AND VOLUME MATCHING,” and in U.S. Patent Publication No. 2004/0034591 to Waelbroeck, entitled “Method and system for managing distributed trading data”.

The following material is incorporated by reference herein in its entirety: U.S. Pat. No. 8,538,849, entitled Methods and Systems Regarding Volatility Risk Premium Index; and an article by the European Equity Derivatives Research of J. P. Morgan Securities Ltd. entitled “Variance Swaps,” available at: http://quantlabs.net/academy/download/free_quant_instituitional_books_/%5BJP%20Morgan%5D%20Variance%20Swaps.pdf.

The following are exemplary embodiments:

A1. A method comprising:

receiving, by at least one processor in electronic communication with at least one user over a computer network, from a user indicia indicating a trading product having a price defined as a differential to a reference product;

determining, by the at least one processor, a price of the reference product;

calculating, by the at least one processor, a price of the trading product by adding the differential to or subtracting the differential from the price of the reference product; and

transmitting the calculated price via a network to an output device, wherein the calculated price is output at the output device.

A2. The method of embodiment A1, in which the trading product is a variance swap.

A3. The method of embodiment A1, in which the reference product is a volatility index.

A4. The method of embodiment A1, in which the reference product is VIX.

A5. The method of embodiment A1, in which the reference product is a U.S. Treasury note.

A6. The method of embodiment A1, further comprising:

causing, by the at least one processor, the trading product to be settled at a price determined based on the calculated price of the trading product.

B. An apparatus comprising: at least one processor; and at least one memory, in electronic communication with the at least one processor, having instructions stored thereon which, when executed by the at least one processor, direct the at least one processor to perform the method of any of embodiments A1-A6.

C. A non-transitory machine-readable medium having instructions stored thereon that are configured to, when executed by the at least one processor, direct the at least one processor to perform the method of any of embodiments A1-A6.

The disclosures of the above-identified patents and patent applications, and all other patent applications and other documents referenced in this patent application, are incorporated by reference herein in their entireties.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A method comprising:
receiving, by at least one processor in electronic communication with at least one user over a computer network, from a user indicia indicating a trading product having a price defined as a differential to a reference product;
determining, by the at least one processor, a price of the reference product;
calculating, by the at least one processor, a price of the trading product by adding the differential to or subtracting the differential from the price of the reference product; and
transmitting the calculated price via a network to an output device, wherein the calculated price is output at the output device.

2. The method of claim 1, in which the trading product is a variance swap.

3. The method of claim 1, in which the reference product is a volatility index.

4. The method of claim 1, in which the reference product is VIX.

5. The method of claim 1, in which the reference product is a U.S. Treasury note.

6. The method of claim 1, further comprising:
causing, by the at least one processor, the trading product to be settled at a price determined based on the calculated price of the trading product.

7. An apparatus comprising:
at least one processor; and
at least one memory, in electronic communication with the at least one processor, having instructions stored thereon which, when executed by the at least one processor, direct the at least one processor to:
receive from a user indicia indicating a trading product having a price defined as a differential to a reference product;
determine a price of the reference product;
calculate a price of the trading product by adding the differential to or subtracting the differential from the price of the reference product; and
transmit the calculated price via a network to an output device, wherein the calculated price is output at the output device.

8. The apparatus of claim 7, in which the trading product is a variance swap.

9. The apparatus of claim 7, in which the reference product is a volatility index.

10. The apparatus of claim 7, in which the reference product is VIX.

11. The apparatus of claim 7, in which the reference product is a U.S. Treasury note.

12. The apparatus of claim 7, in which the instructions, when executed by the at least one processor, further direct the at least one processor to:
cause the trading product to be settled at a price determined based on the calculated price of the trading product.

13. The apparatus of claim 7, in which the output device comprises a display device, and in which instructions, when executed, further cause the calculated price to be displayed at the display device.

14. A non-transitory machine-readable medium having instructions stored thereon that are configured to, when executed by the at least one processor, direct the at least one processor to:
receive from a user indicia indicating a trading product having a price defined as a differential to a reference product;
determine a price of the reference product;
calculate a price of the trading product by adding the differential to or subtracting the differential from the price of the reference product; and
transmit the calculated price via a network to an output device, wherein the calculated price is output at the output device.

15. The non-transitory machine-readable medium of claim 14, in which the trading product is a variance swap.

16. The non-transitory machine-readable medium of claim 14, in which the reference product is a volatility index.

17. The non-transitory machine-readable medium of claim 14, in which the reference product is VIX.

18. The non-transitory machine-readable medium of claim 14, in which the reference product is a U.S. Treasury note.

19. The non-transitory machine-readable medium of claim 14, in which instructions, when executed, further direct the at least one processor to:
cause the trading product to be settled at a price determined based on the calculated price of the trading product.
